(19) United States
(12) Patent Application Publication
(10) Pub. No.: US 2024/0357045 A1
(43) Pub. Date: Oct. 24, 2024

(54) IMAGE FORMING APPARATUS AND REPLACEMENT METHOD

(71) Applicant: Konica Minolta, Inc., Tokyo (JP)

(72) Inventor: Kouki MURAMOTO, Toyohashi-shi (JP)

(21) Appl. No.: 18/629,684

(22) Filed: Apr. 8, 2024

(30) Foreign Application Priority Data
Apr. 18, 2023 (JP) 2023-068117

(51) Int. Cl. H04N 1/00

(52) U.S. Cl. CPC H04N 1/00538; H04N 1/00557; H04N 1/00559; H04N 1/00602; H04N 1/0062; H04N 2201/0094

(57) ABSTRACT

An image forming apparatus includes a roller that is involved in conveyance of a sheet-like medium, a receiver that electrically or mechanically receives a trigger for replacement of the roller, and an allower that, in response to the trigger received by the receiver, allows movement of the roller to a position different from a position where the roller is normally used in the image forming apparatus.

### CROSS-REFERENCE TO RELATED APPLICATIONS

The entire disclosure of Japanese patent Application No. 2023-068117 filed on Apr. 18, 2023, is incorporated herein by reference in its entirety.

### BACKGROUND OF THE INVENTION

### Technical Field

The present invention relates to an image forming apparatus and a replacement method. In particular, the present invention relates to an image forming apparatus that conveys a sheet-like medium by using a roller and a replacement method of replacing the roller.

### Description of Related Art

In recent years, in order to form an image on a sheet-like medium such as a sheet, an image forming apparatus represented by a multi-functional peripheral includes a mechanism that conveys a sheet-like medium by using a roller. A sheet-like medium is conveyed using a friction force between the roller and the sheet-like medium. Therefore, in a case in which the roller wears and the friction force between the roller and the sheet-like medium is reduced, it is necessary to replace the roller. Since the roller is often disposed in a limited narrow space, it is difficult to view and detach the roller. The roller may be damaged by hitting another portion at the time of attachment.

Japanese Unexamined Patent Publication No. 2014-162561 describes an image forming apparatus that includes a feeder that is provided in a main body of the apparatus and sends out a recording medium from a recording medium storage cassette, and a cover member that is arranged at one side surface of the main body of the apparatus to be openable and closable, and arranged to be adjacent to a downstream position in a recording medium sending direction of the feeder, wherein the feeder includes a pickup roller that sends out a recording medium, a feed roller that conveys a recording medium that has been sent out by the pickup roller, and a retard roller that is pressed against the feed roller, and the feeder projects from one side surface of the main body of the apparatus with the feed roller and the retard roller pressed against each other in response to an operation of opening the cover member.

In the image forming apparatus described in Japanese Unexamined Patent Publication No. 2014-162561, because the position of the pickup roller does not change, it is difficult to replace the pickup roller. Further, the feed roller and the retard roller are positioned with respect to the cover member. Therefore, in order to determine the relative position of the pickup roller with respect to the feed roller and the retard roller, it is necessary to improve the positioning accuracy after the cover member is closed. Therefore, a mechanism that increases the strength of the cover member and positions the cover member with respect to the main body of the apparatus is required. As a result, labor is required for an operation of opening and closing the cover member due to an increase in weight of the cover member. Further, there is a problem that an operation for positioning the cover member with respect to the main body of the apparatus is complicated.

### SUMMARY OF THE INVENTION

According to one aspect of the present invention, an image forming apparatus includes a roller that is involved in conveyance of a sheet-like medium in the image forming apparatus, a receiver that electrically or mechanically receives a trigger for replacement of the roller, and an allower that, in response to the trigger received by the receiver, allows movement of the roller to a position different from a position where the roller is normally used in the image forming apparatus.

According to another aspect of the present invention, a replacement method of replacing a roller that is involved in conveyance of a sheet-like medium in an image forming apparatus includes the steps of electrically or mechanically receiving a trigger for replacement of the roller, and in response to reception of the trigger, allowing movement of the roller to a position different from a position where the roller is normally used in the image forming apparatus.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a front view of an MFP in one embodiment of the present invention;

FIG. 2 is a schematic cross-sectional view illustrating the inner configuration of the MFP;

FIG. 3 is a perspective view illustrating one example of a pickup mechanism;

FIG. 4 is a first cross-sectional view of a portion around the pickup mechanism;

FIG. 5 is a perspective view of the MFP;

FIG. 6 is a second cross-sectional view of the portion around the pickup mechanism;

FIG. 7 is a third cross-sectional view of the portion around the pickup mechanism;

FIG. 8 is a fourth cross-sectional view of the portion around the pickup mechanism;

FIG. 9 is a first perspective view of a state in which a cover member is opened;

FIG. 10 is a fifth cross-sectional view of the portion around the pickup mechanism; and

FIG. 11 is a second perspective view in a state in which the cover member is opened.

### DETAILED DESCRIPTION

Hereinafter, one or more embodiments of the present invention will be described with reference to the drawings. However, the scope of the invention is not limited to the disclosed embodiments.

Although embodiments of the present invention have been described and illustrated in detail, the disclosed embodiments are made for purpose of illustration and example only and not limitation. The scope of the present invention should be interpreted by terms of the appended claims.

Embodiments of the present invention will be described below with reference to the drawings. In the following description, the same components are denoted by the same reference numerals. Their names and functions are the same. Therefore, a detailed description thereof will not be repeated.

In the following description, a Multi Function Peripheral (MFP) will be described as one example of an image forming apparatus. The MFP forms an image on a sheet-like medium. A sheet-like medium includes a sheet such as a paper or an Overhead Projector (OHP) film. Here, a sheet is used as a sheet-like medium by way of example.

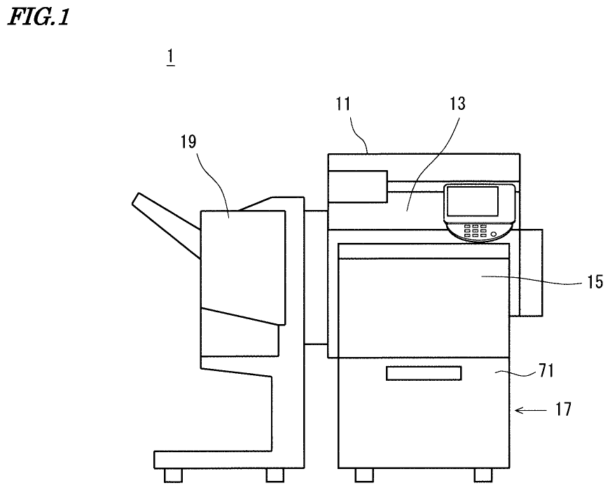

FIG. 1 is a front view of an MFP in one embodiment of the present invention. With reference to FIG. 1, the Multi Function Peripheral (MFP) 1 includes an automatic document conveyance apparatus 11, a document reading section 13, an image forming section 15, a sheet feed section 17 and a post-processing section 19.

The automatic document conveyance apparatus 11 automatically conveys a plurality of documents set on a document tray to a document reading position of the document reading section 13 one by one, and discharges a document having an image formed thereon and read by the document reading section 13 to a document ejection tray. The document reading section 13 includes a light source that irradiates a document that has been conveyed to the document reading position with light and an optoelectronic transducer that receives the light reflected from the document, and scans a document image corresponding to the size of the document. The optoelectronic transducer converts the received light into image data that is an electrical signal. The document reading section 13 outputs the image data which is acquired when a document is read. The document reading section 13 stores the image data in a storage device such as a hard disc drive (HD).

The sheet feed section 17 includes a sheet feed tray 71 that contains sheets which are sheet-like media. The sheet feed tray 71 can store a plurality of sheets. Further, the image forming section 15 can be pulled out forwardly from the front of the MFP 1 in order for a user to feed sheets. Hereinafter, a state in which the sheet feed tray 71 is pulled out is referred to as an open state, and a state before the sheet feed tray 71 is pulled out is referred to as a close state. The sheet feed tray 71 is a cube having an open upper side, and the user can feed a bundle of sheets including a plurality of sheets from the upper side in the open state. The sheet feed section 17 conveys the plurality of sheets stored in the sheet feed tray 71 to the image forming section 15 one by one.

The image forming section 15 forms an image using a well-known electrophotographic method, forms an image on a sheet conveyed by the sheet feed section 17 based on image data, and discharges the sheet having an image formed thereon to a sheet ejection tray.

The sheet feed section 17 performs a sorting process of sorting and discharging one or more sheets on which images are formed by the image forming section 15, a punch process of punching the sheets and a stapling process of stapling the sheets.

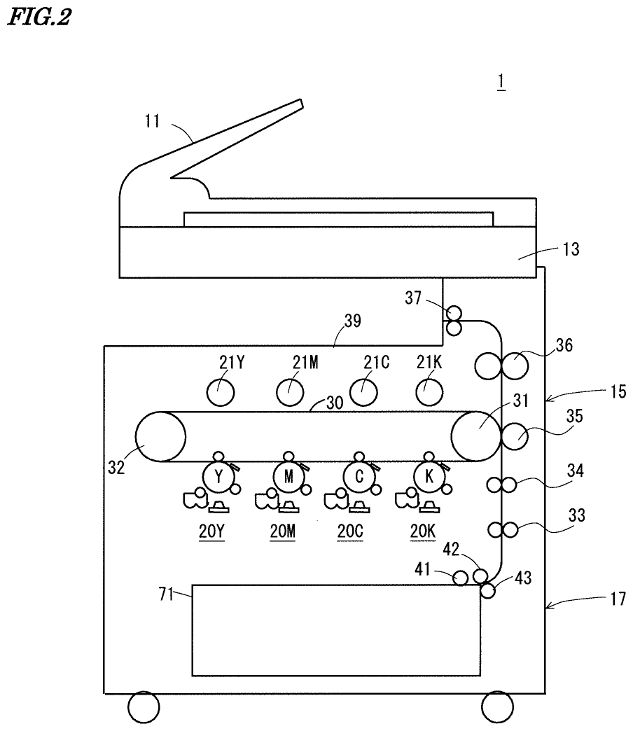

FIG. 2 is a schematic cross-sectional view illustrating the inner configuration of the MFP. With reference to FIG. 2, the image forming section 15 has developing units 20Y, 20M, 20C, 20K and toner bottles 21Y, 21M, 21C, 21K, corresponding to yellow, magenta, cyan and black, respectively. Here, “Y,” “M,” “C” and “K” represent yellow, magenta, cyan and black, respectively.

The only difference among the developing units 20Y, 20M, 20C, 20K is the color of toner used by the developing units 20Y, 20M, 20C, 20K. Further, the only difference among the toner bottles 21Y, 21M, 21C, 21K is the color of toner used by the toner bottles 21Y, 21M, 21C, 21K. Therefore, the developing unit 20Y and the toner bottle 21Y for forming an image in yellow will be described here.

The toner bottle 21Y contains yellow toner. The toner bottle 21Y is rotated by a toner bottle motor serving as a drive source to discharge a toner to the outside. The toner discharged from the toner bottle 21Y is supplied to the developing unit 20Y. The toner bottle 21Y supplies a developer to the developing unit 20Y in response to the remaining amount of the toner, contained in the developing unit 20Y, becoming equal to or smaller than a predetermined lower limit value.

The intermediate transfer belt 30 is suspended by a driving roller 31 and a driven roller 32 so as not to loosen. When the driving roller 31 is rotated in the counterclockwise direction in FIG. 2, the intermediate transfer belt 30 is rotated in the counterclockwise direction in the diagram at a predetermined speed. The driven roller 32 is rotated in the counterclockwise direction in accordance with rotation of the intermediate transfer belt 30.

The developing unit 20Y contains the developer. The developer includes a non-magnetic toner and a magnetic carrier. The developing unit 20Y is supplied with the toner by the toner bottle 21Y, and stirs the carrier and the toner. The developing unit 20Y forms a toner image with the toner included in the developer, and transfers the toner image onto the intermediate transfer belt 30. The timing for transferring toner images onto the intermediate transfer belt 30 by the developing unit 20Y is adjusted by detection of a reference mark provided on the intermediate transfer belt 30.

When forming a full-color image, the MFP 1 drives all of the developing units 20Y, 20M, 20C, 20K. Thus, toner images in yellow, magenta, cyan and black are superimposed on the intermediate transfer belt 30. When forming a monochrome image, the MFP 1 drives any one of the developing units 20Y, 20M, 20C, 20K. Further, it is also possible to form an image by combining two or more of the developing units 20Y, 20M, 20C, 20K.

In the MFP1 in the present embodiment, a plurality of types of rollers are arranged on a sheet conveyance path. Each of the plurality of types of rollers basically has a columnar shape and rotates about a rotation center axis to bring a side surface thereof into contact with a sheet.

The MFP1 includes a pickup roller 41, a sheet feed roller 42, a separation roller 43, a conveyance roller 33, a timing roller 34, a transfer roller 35, a fixing roller 36 and a discharge roller 37. Each of the pickup roller 41, the sheet feed roller 42, the conveyance roller 33, the timing roller 34, the fixing roller 36 and the discharge roller 37 is rotated by a rotational force transmitted from a drive source such as a motor, thereby conveying a sheet by utilizing a frictional force generated in a portion coming into contact with the sheet. Further, no rotational force is transmitted from the drive source to the separation roller 43 and the transfer roller 35.

A plurality of sheets are set in the sheet feed tray 71. The plurality of sheets contained in the sheet feed tray 71 are picked up in order from a sheet at the top by the pickup roller 41 provided in correspondence with the sheet feed tray 71. A sheet that has been picked up by the pickup roller 41 is conveyed by the sheet feed roller 42 and enters the conveyance path. The sheet that has been conveyed to the conveyance roller 33 by the sheet feed roller 42 is further conveyed by the conveyance roller 33 and reaches the timing roller 34 through the conveyance path.

The timing roller 34 conveys the sheet that has been conveyed by the conveyance roller 33 at a predetermined point in time. The sheet conveyed along the conveyance path by the timing roller 34 enters a nip portion formed between the intermediate transfer belt 30 and the transfer roller 35. A point in time at which the timing roller 34 starts conveyance of a sheet is determined based on a point in time at which a toner image formed on the intermediate transfer belt 30 reaches the nip portion. Thus, the toner image can be transferred to a predetermined position of the sheet.

The transfer roller 35 generates an electric field in the nip portion. In a period during which the sheet that has entered the nip portion passes through the nip portion, the toner image formed on the intermediate transfer belt 30 is transferred onto the sheet by the effect of an electric field force generated in the nip portion. The sheet onto which the toner image has been transferred is conveyed to the fixing roller 36 along the conveyance path. The fixing roller 36 conveys the sheet and applies heat and pressure to the sheet. The sheet and the toner image that has been transferred onto the sheet are heated and pressurized by the fixing roller 36 while passing through the fixing roller 36. Thus, the toner is fused and the toner image is fixed to the sheet. The sheet conveyed by the fixing roller 36 is conveyed to the discharge roller 37 along the conveyance path. The discharge roller 37 discharges the sheet to the sheet ejection tray 39.

While the MFP 1 that uses a tandem system including the developing units 24Y, 24M, 24C, 24K that form toners of four colors on a sheet is described here by way of example, a four-cycle system that sequentially transfer toners of four colors onto a sheet by one photosensitive drum may be used.

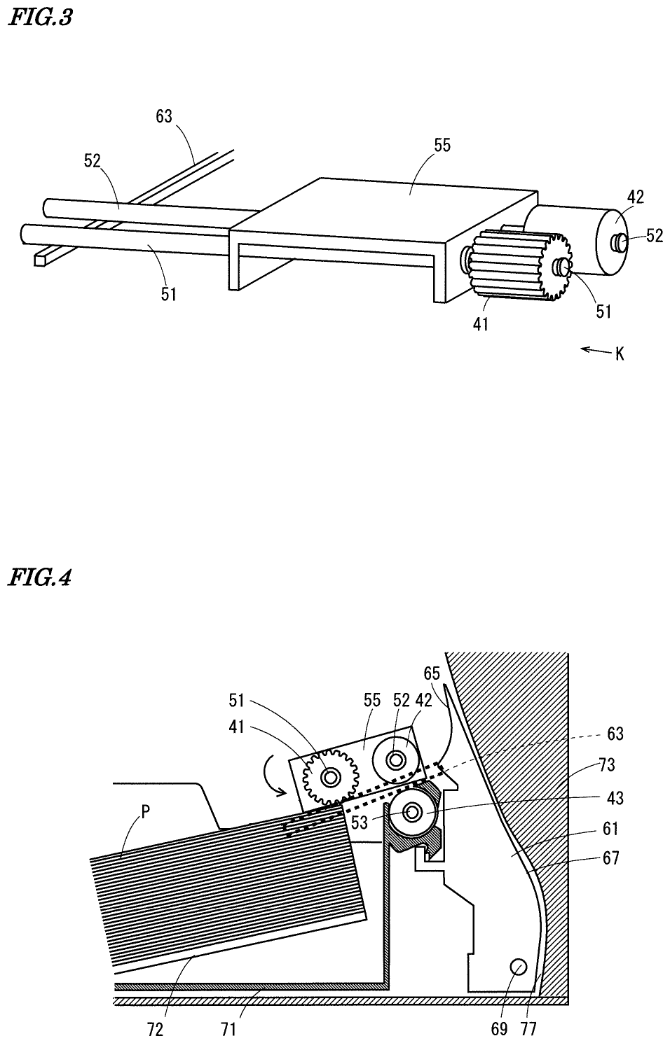

FIG. 3 is a perspective view illustrating one example of a pickup mechanism. With reference to FIG. 3, the arrow K indicates the direction from the front toward the back of the MFP 1. The pickup mechanism includes a main drive shaft 52 pivotably supported at a main body case, a bearing base 55 rotatably attached to the main drive shaft 52, the sheet feed roller 42 attached to the main drive shaft 52, a sub-drive shaft 51 pivotably supported at the bearing base 55, and the pickup roller 41 attached to the sub-drive shaft 51.

The main drive shaft 52 is pivotally supported at the main body case and is rotated by a motor (not illustrated). The sheet feed roller 42 is attachable to and detachable from the main drive shaft 52. In a case in which being attached to the main drive shaft 52, the sheet feed roller 42 is fixed in a rotation direction and a rotation axial direction of the main drive shaft 52. The sheet feed roller 42 is attachable to and detachable from the main drive shaft 52. In a case in which being attached to the main drive shaft 52, the sheet feed roller 42 is fixed in a rotation direction and a rotation axial direction of the main drive shaft 52. Therefore, while being attached to the main drive shaft 52, the sheet feed roller 42 is rotated with the main drive shaft 52 as a rotation shaft in accordance with rotation of the main drive shaft 52. While being rotatable about the main drive shaft 52, the bearing base 55 is positioned at and attached to a predetermined position in the axial direction of the main drive shaft 52. The bearing base 55 pivotally supports the sub-drive shaft 51 such that the sub-drive shaft 51 is parallel to the main drive shaft 52. A rotation amount by which the bearing base 55 is rotatable about the main drive shaft 52 is defined based on the height of the sub-drive shaft 51. The upper limit of the height of the sub-drive shaft 51 is restricted by a stopper attached to the main body case. Further, the lower limit of the height of the sub-drive shaft 51 is restricted by a restrictor 63, described below. Therefore, the bearing base 55 is rotatable about the main drive shaft 52 between an upper limit position which is the highest position of the sub-drive shaft 51 and a lower limit position which is the lowest position of the sub-drive shaft 51. FIG. 3 illustrates the bearing base 55 being located at the lower limit position.

The main drive shaft 52 and the sub-drive shaft 51 are coupled by a gear or a belt, and a rotational force of the motor is transmitted to the main drive shaft 52. When the main drive shaft 52 receives a rotational force from the motor to be rotated, the sub-drive shaft 51 is rotated. The pickup roller 41 is attachable to and detachable from the sub-drive shaft 51. While being attached to the sub-drive shaft 51, the pickup roller 41 is fixed in a rotation direction and a rotation axial direction of the sub-drive shaft 51. Therefore, while being attached to the sub-drive shaft 51, the pickup roller 41 is rotated with the sub-drive shaft 51 as a rotation shaft in accordance with rotation of the sub-drive shaft 51.

FIG. 4 is a first cross-sectional view of the portion around the pickup mechanism. FIG. 4 illustrates the portion around the pickup mechanism in the cross section taken along the plane orthogonal to the direction from the front toward the back of the MFP 1. With reference to FIG. 4, the sheet feed tray 71 has a lifting-lowering plate 72 in a bottom portion. A plurality of sheets P are placed on the lifting-lowering plate 72. When the lifting-lowering plate 72 is lifted, the uppermost surface of the plurality of sheets P abuts against the pickup roller 41.

The sub-drive shaft 51 of the pickup roller 41 is biased downwardly by an elastic member such as a spring. When the lifting-lowering plate 72 is further lifted with the uppermost surface of the plurality of sheets P abutting against the pickup roller 41, a force for lifting the lifting-lowering plate 72 exceeds an elastic force of the elastic member, and the pickup roller 41 is lifted. A sensor that measures the height of the pickup roller 41 is provided, and the lifting of the lifting-lowering plate 72 is stopped when the pickup roller 41 reaches a predetermined height. Therefore, with the pickup roller 41 abutting against the uppermost surface of the sheets P, the pickup roller 41 downwardly presses the sheets P with a predetermined force. In this state, when the pickup roller 41 is rotated, the uppermost sheet of the sheets P is conveyed toward the sheet feed roller 42 by a frictional force generated between the uppermost sheet and the pickup roller 41.

The separation roller 43 is pivotally supported at the side wall of the sheet feed tray 71. With the sheet feed tray 71 closing the main body case of the MFP 1, the separation roller 43 is positioned at the position opposite to the pickup roller 41. Further, with the sheet feed tray 71 closing the main body case of the MFP 1, the rotation shaft of the separation roller 43 is biased in the direction toward the sheet feed roller 42 by an elastic member such as a spring. With no sheet being present between the sheet feed roller 42 and the separation roller 43, the separation roller 43 comes into contact with the sheet feed roller 42 and is rotated in accordance with rotation of the sheet feed roller 42. However, a resistance for restricting rotation of the separation roller 43 is provided in the rotation shaft of the separation roller 43.

Two or more sheets may be picked up from the sheet feed tray 71 by the pickup roller 41 in an overlapping manner. In this case, a bundle of two or more sheets enters between the sheet feed roller 42 and the separation roller 43. The uppermost sheet of the two or more sheets comes into contact with the sheet feed roller 42, and the lowermost sheet of the two or more sheets comes into contact with the separation roller 43. Here, two sheets P1, P2 overlap with each other, by way of example. It is defined that a dynamic friction coefficient between the sheet feed roller 42 and the uppermost sheet P1 is μ1, a static friction coefficient between the separation roller 43 and the lowermost sheet P2 is μ2, and a static friction coefficient between the uppermost sheet P1 and the lowermost sheet P2 is μ3. The outer peripheral surface of each of the sheet feed roller 42 and the separation roller 43 is formed of a material satisfying the relationship of μ1>μ3 and μ2>μ3, and is subjected to surface treatment.

When the plurality of sheets P1, P2 advance to the position between the sheet feed roller 42 and the separation roller 43, a resistance for restricting rotation is provided in the sheet feed roller 42. Therefore, a force directed in the direction opposite to the conveyance direction is generated. Because μ2>μ3, the separation roller 43 is not rotated and is stopped while being in contact with the sheet P2. Further, because μ1>μ3, the friction force, which the sheet P1 receives from the sheet feed roller 42, exceeds the friction force, which the sheet P1 receives from the sheet P2, and the sheet P1 is conveyed by the sheet feed roller 42.

The cover member 61 has a path surface 65 that is directed toward the sheet feed roller 42. Further, the cover member 61 has a first lower path surface 67 opposite to the path surface 65. The sheet P1 conveyed by the sheet feed roller 42 advances along the path surface 65 of the cover member 61.

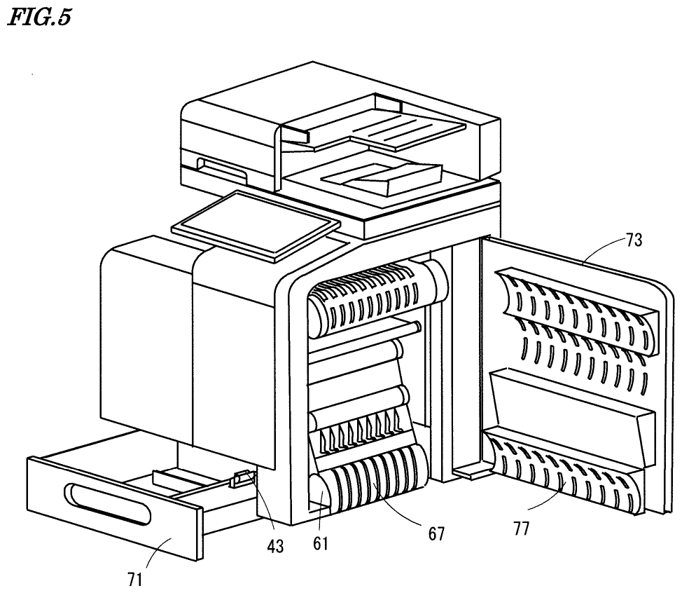

FIG. 5 is a perspective view of the MFP. FIG. 5 illustrates the MFP 1 with the sheet feed tray 71 being pulled out from the main body case of the MFP 1 and with an exterior cover 73 being opened. With the exterior cover 73 being opened, the first lower path surface 67 of the cover member 61 is exposed to the outside of the main body. A second lower path surface 77 forming part of the conveyance path is formed at the inner surface of the exterior cover 73. With the exterior cover 73 being closed, the first lower path surface 67 and the second lower path surface 77 face each other, and a conveyance path through which a sheet passes is formed therebetween. Note that the conveyance path formed of the first lower path surface 67 and the second lower path surface 77 is a path through which, in a case in which an extra sheet feed tray is installed below the sheet feed tray 71, a sheet picked up from the sheet feed tray below the sheet feed tray 71 is conveyed.

In the sheet feed tray 71, the separation roller 43 is attached to the side surface close to the exterior cover 73. With the sheet feed tray 71 being pulled out from the main body case of the MFP 1, the rotation shaft of the separation roller 43 is released from being biased by the elastic member, and is located at a position to which the sheet feed tray 71 is lowered by gravity from a position where the sheet feed tray 71 is located with the sheet feed tray 71 closing the main body case of the MFP 1.

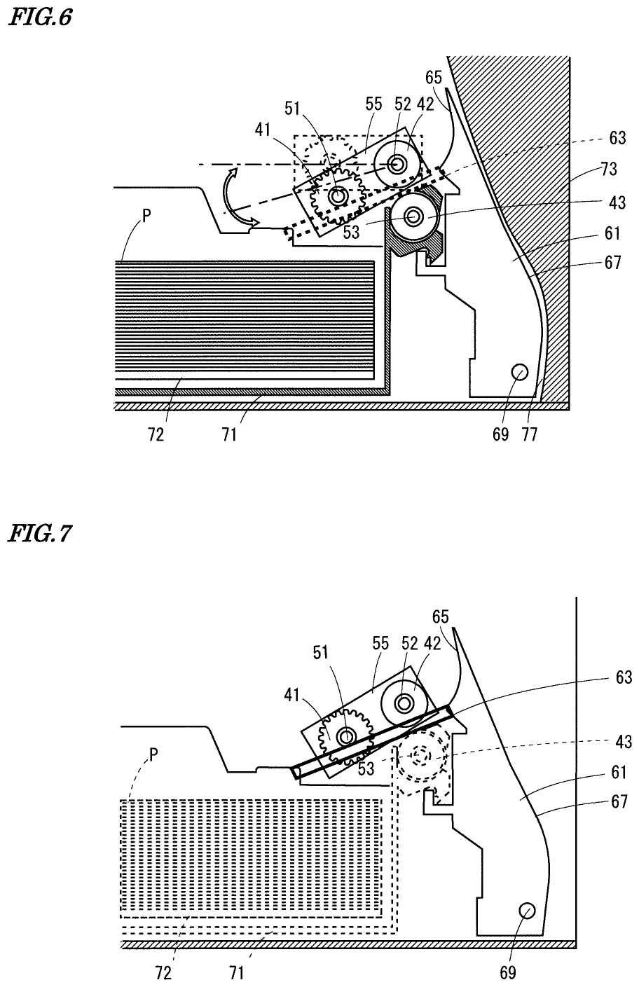

FIG. 6 is a second cross-sectional view of the portion around the pickup mechanism. Unlike FIG. 4, FIG. 6 illustrates the state in which the lifting-lowering plate 72 of the sheet feed tray 71 is lowered to the lower limit position and the rotation shaft of the separation roller 43 is released from being biased by the elastic member. For example, in response to a user's operation of a lever provided at the sheet feed tray 71, the lifting-lowering plate 72 is lowered to the lower limit position, and the rotation shaft of the separation roller 43 is released from being biased by the elastic member. In this state, the sheet feed tray 71 can be pulled out from the main body case of the MFP 1.

In the cover member 61, a guide rotation shaft 69 is pivotally supported at the main body case of the MFP 1. By being rotated about the guide rotation shaft 69, the cover member 61 can be moved to a first position when being closed and can be moved to a second position when being opened. FIG. 6 illustrates the state in which the cover member 61 is closed and located at the first position. The cover member 61 has, below the path surface 65, the restrictor 63 extending in the direction opposite to the direction toward the first lower path surface 67. The restrictor 63 is located closer to the back of the MFP 1 than the conveyance path through which a sheet passes in the direction from the front toward the back of the MFP 1. Therefore, the restrictor 63 does not interfere with a sheet to be conveyed by the pickup roller 41 and the sheet feed roller 42.

With the cover member 61 located at the first position, the restrictor 63 is located below the sub-drive shaft 51. The sub-drive shaft 51 biased in the downward direction by the elastic member is located at a position where the sub-drive shaft 51 abuts against the restrictor 63, and the pickup mechanism does not abut against the sheet feed tray 71. Therefore, in a case in which being pulled out of the main body case, the sheet feed tray 71 does not interfere with the pickup mechanism.

FIG. 7 is a third cross-sectional view of the portion around the pickup mechanism. Unlike FIG. 6, FIG. 7 illustrates the state in which the sheet feed tray 71 is pulled out from the main body case and the exterior cover 73 is opened. With the cover member 61 being closed, the sub-drive shaft 51 is maintained at the position where the sub-drive shaft 51 abuts against the restrictor 63. Further, because the cover member 61 is located at the first position, even with the exterior cover 73 being opened as illustrated in FIG. 5, the pickup mechanism cannot be accessed.

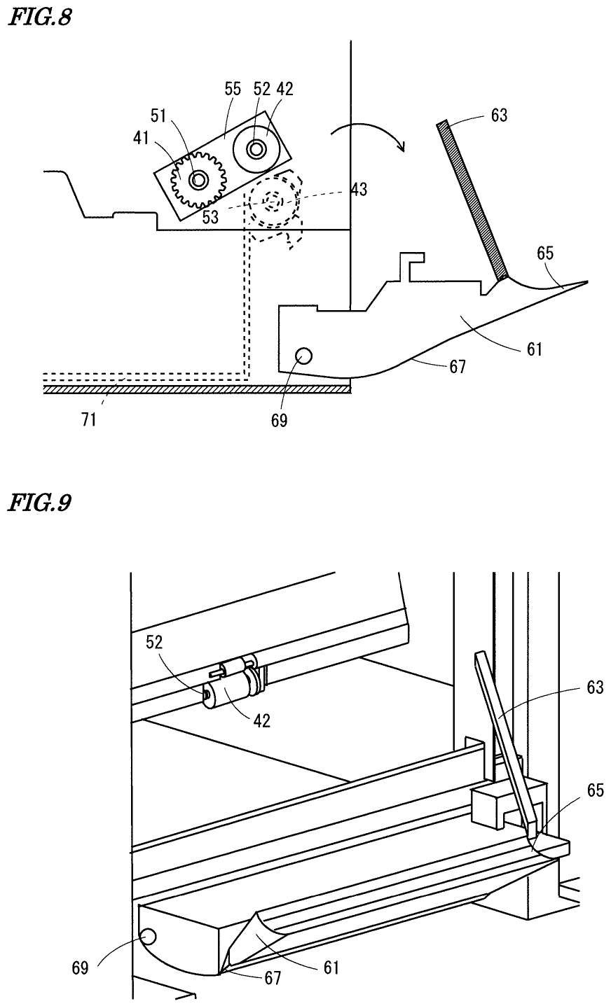

FIG. 8 is a fourth cross-sectional view of the portion around the pickup mechanism. Unlike FIG. 7, FIG. 8 illustrates the state in which the cover member 61 is located at the second position. FIG. 9 is a first perspective view of the state in which the cover member is located at the second position. With reference to FIGS. 8 and 9, with the cover member 61 located at the second position, the space around the pickup mechanism inside the MFP 1 is exposed to the side surface of the main body case of the MFP 1. Therefore, the user can view the pickup roller 41 from the side surface of the main body case, and can insert his/her hand. Further, with the cover member 61 being opened, because the restrictor 63 does not abut against the sub-drive shaft 51, the bearing base 55 can freely be rotated about the main drive shaft 52.

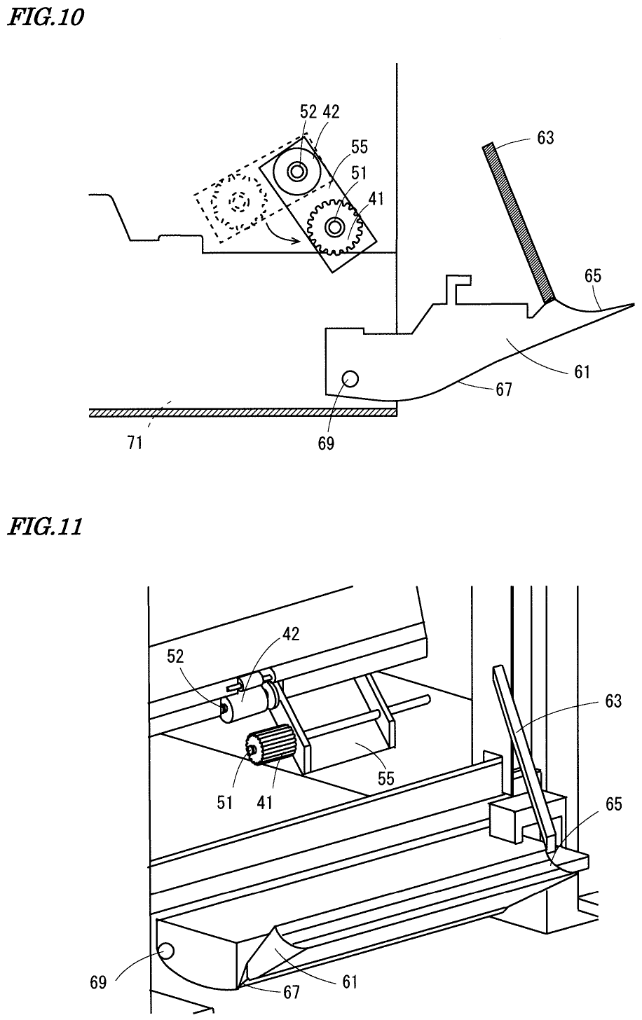

FIG. 10 is a fifth cross-sectional view of the portion around the pickup mechanism. FIG. 11 is a second perspective view of the state in which the cover member is opened. FIGS. 10 and 11 illustrate the state in which the user has downwardly moved the pickup roller 41. The user can view the pickup roller 41 and the sheet feed roller 42, and can downwardly move the pickup roller 41 by inserting his/her hand into an opening which appears when the cover member 61 is opened. This facilitates the user's work of replacing the pickup roller 41 and the sheet feed roller 42.

### OTHER EMBODIMENTS

(1) In the above-mentioned embodiment, in regard to the pickup mechanism, the bearing base 55 is rotatable about the main drive shaft 52, and the sub-drive shaft 51 is moved downwardly by being biased by the elastic member, by way of example. However, the present invention is not limited to this.

A motor may be used to cause the bearing base 55 to be rotated about the main drive shaft 52. By controlling driving of the motor, it is possible to define the position of the sub-drive shaft 51. In this case, the restrictor 63 is not required. It is possible to downwardly move the pickup roller 41 when the user provides an instruction for driving the motor to the MFP 1, for example. A user's instruction for driving the motor may be received as an operation of pressing a button switch provided on an operation panel. A switch that is turned on in response to movement of the cover member 61 from the first position to the second position may be used to receive the user's instruction for driving the motor as an operation of moving the cover member 61 from the first position to the second position.
(2) While the work of replacing the pickup roller 41, the sheet feed roller 42 and the separation roller 43 is described by way of example in the present embodiment, the present invention is not limited to this. A roller to be replaced may be at least one of the driving roller 31, the driven roller 32, the conveyance roller 33, the timing roller 34, the transfer roller 35, the fixing roller 36 and the discharge roller 37.
(3) While the MFP 1 is described as one example of an image forming apparatus in the present embodiment, the present invention is not limited to this. An image forming apparatus may be a printer or a facsimile machine. Further, an image forming function is not limited to an electrophotographic method of forming an image with a toner, and may be an inkjet method of forming an image with ink.

As described above, the MFP 1 in the present embodiment has the pickup roller 41 that is involved in conveyance of a sheet, and the pickup roller 41 is allowed to move to a position different from a position where the pickup roller 41 is normally used in the MFP 1 in response to electrical or mechanical reception of a trigger for replacement of the pickup roller 41. A mechanical trigger is an event in which the cover member 61 is moved from the first position to the second position. In response to the movement of the cover member 61 from the first position to the second position, the restrictor 63 no longer abuts against the sub-drive shaft 51. Therefore, the pickup roller 41 can be moved from the position where the pickup roller 41 is normally used in the MFP 1 to a position different from the position where the pickup roller 41 is normally used. The position where the pickup roller 41 is normally used in the MFP 1 is the position where the pickup roller 41 is located with the cover member 61 located at the first position. Specifically, the position where the pickup roller 41 is normally used in the MFP 1 is a position within the range indicated by the outlined arrow in FIG. 6. The cover member 61 is moved from the first position to the second position, so that the restrictor 63 no longer abuts against the sub-drive shaft 51. Thus, the pickup roller 41 is allowed to move to a position different from the position where the pickup roller 41 is normally used in the MFP 1.

Further, an electrical trigger for replacement of the pickup roller 41 is generated in a case in which the bearing base 55 is rotated about the main drive shaft 52 using a motor. This electrical trigger is an operation of pressing a button switch provided on the MFP 1. Alternatively, in a case in which a switch that is turned on in response to the movement of the cover member 61 from the first position to the second position is provided, this electrical trigger is an operation of moving the cover member 61 from the first position to the second position.

When a trigger for replacement of the pickup roller 41 is electrically or mechanically received, the pickup roller 41 is allowed to move to a position different from the position where the pickup roller 41 is normally used in the MFP 1. This facilitates the work of replacing the pickup roller 41.

Further, in regard to the cover member 61, the path surface 65 forms at least part of the conveyance path through which a sheet to be conveyed by the pickup roller 41 passes when the cover member 61 is located at the first position with the main body case being closed, and the path surface 65 does not form the conveyance path when the cover member 61 is located at the second position with the main body case being opened. With the cover member 61 located at the first position, the restrictor 63 abuts against the sub-drive shaft 51. Therefore, the pickup roller 41 is restricted from moving to a position different from the position where the pickup roller 41 is normally used in the MFP 1. In other words, with the cover member 61 located at the first position with the path surface 65 of the cover member 61 forming at least part of the conveyance path, the pickup roller 41 is located at the position where the pickup roller 41 is normally used in the MFP 1. Therefore, it is possible to maintain a state in which the pickup roller 41 can convey a sheet to the conveyance path.

The pickup roller 41 picks up a sheet stored in the sheet feed tray 71, and the bearing base 55 pivotally supports the sub-drive shaft 51 of the pickup roller 41 and is rotatable about the main drive shaft 52 opposite to the sub-drive shaft 51. The bearing base 55 is rotated about the main drive shaft 52, so that the pickup roller 41 is moved between the position where the pickup roller 41 is normally used and a position different from the position where the pickup roller 41 is normally used. Therefore, it is possible to cause the pickup roller 41 to be moved between the position where the pickup roller 41 is normally used and a position where the pickup roller 41 is not normally used by rotating the bearing base 55 about the main drive shaft 52. Therefore, the pickup roller 41 can be easily replaced.

The MFP1 includes the sheet feed roller 42 that conveys a sheet that has been picked up by the pickup roller 41, and the separation roller 43 provided opposite to the sheet feed roller 42 and pressed against the sheet feed roller 42. With the separation roller 43 moved to a position where the separation roller 43 does not press the sheet feed roller 42, the MFP 1 allows the pickup roller 41 to be moved to a position different from the position where the pickup roller 41 is normally used. With the separation roller 43 moved to a position where the separation roller 43 does not press the sheet feed roller 42, the pickup roller 41 is moved to a position different from the position where the pickup roller 41 is normally used. Therefore, with the separation roller 43 located at a position where the separation roller 43 presses the sheet feed roller 42, the pickup roller 41 is not moved to a position different from the position where the pickup roller 41 is normally used. Therefore, the pickup roller 41 can be prevented from being damaged.

### Overview of Embodiments

(Item 1) An image forming apparatus includes a roller that is involved in conveyance of a sheet-like medium in the image forming apparatus, a receiver that electrically or mechanically receives a trigger for replacement of the roller, and an allower that, in response to the trigger received by the receiver, allows movement of the roller to a position different from a position where the roller is normally used in the image forming apparatus.

According to this aspect, when a trigger for replacement of the roller is electrically or mechanically received, the roller is allowed to move to a position different from the position where the roller is usually used in the image forming apparatus. Therefore, it is possible to provide the image forming apparatus that facilitates the work of replacing the roller.

(Item 2) The image forming apparatus according to item 1 further includes a cover member that is movable between a first position where the cover member forms at least part of a conveyance path through which the sheet-like medium that is conveyed by the roller passes and a second position where the cover member does not form the conveyance path, wherein the allower, with the cover member located at the first position, does not allow movement of the roller to a position different from the position where the roller is normally used in the image forming apparatus.

According to this aspect, with the cover member being located at the first position, the roller is not allowed to move to a position different from the position where the roller is normally used in the image forming apparatus. Therefore, with the cover member forming at least part of the conveyance path, the roller is located at the position where the roller is normally used in the image forming apparatus. Therefore, it is possible to maintain a state in which the roller can convey a sheet-like medium to the conveyance path.

(Item 3) The image forming apparatus according to item 2, wherein the cover member includes a restriction member that restricts movement of the roller with the cover member located at the first position.

According to this aspect, because the movement of the roller is restricted by the restriction member with the cover member located at the first position, the roller can be located at the position where the roller is normally used in the image forming apparatus.

(Item 4) The image forming apparatus according to any one of items 1 to 3 further includes a sheet feed tray that stores a plurality of the sheet-like media in a stack, wherein the roller is a pickup roller that picks up the sheet-like medium stored in the sheet feed tray, the image forming apparatus further includes a connection member that pivotally supports a first rotation shaft and is rotatable about a second rotation shaft different from the first rotation shaft, and the pickup roller is moved between the position where the pickup roller is normally used and a position different from the position where the pickup roller is normally used by rotation of the connection member about the second rotation shaft.

According to this aspect, it is possible to move the pickup roller between the position where the pickup roller is normally used and a position where the pickup roller is not normally used by rotating the connection member about the second rotation shaft. Therefore, the pickup roller can be easily replaced.

(Item 5) The image forming apparatus according to item 4 further includes a sheet feed roller that conveys the sheet-like medium that has been picked up by the pickup roller, and a separation roller that is provided opposite to the sheet feed roller and pressed against the sheet feed roller, wherein the allower, with the separation roller moved to a position where the separation roller does not press the sheet feed roller, allows movement of the pickup roller to a position different from the position where the pickup roller is normally used.

According to this aspect, with the separation moved to a position where the separation roller does not press the sheet feed roller, the pickup roller is moved to a position different from the position where the pickup roller is normally used. Therefore, because the pickup roller is not moved to a position different from the position where the pickup roller is normally used with the separation roller located at a position where the separation roller presses the sheet feed roller, the pickup roller can be prevented from being damaged.

(Item 6) A replacement method of replacing a roller that is involved in conveyance of a sheet-like medium in an image forming apparatus includes the steps of electrically or mechanically receiving a trigger for replacement of the roller, and in response to reception of the trigger, allowing movement of the roller to a position different from a position where the roller is normally used in the image forming apparatus.

According to this aspect, it is possible to provide a replacement method that facilitates the work of replacing the roller.

What is claimed is:

1. An image forming apparatus comprising:
a roller that is involved in conveyance of a sheet-like medium in the image forming apparatus;
a receiver that electrically or mechanically receives a trigger for replacement of the roller; and
an allower that, in response to the trigger received by the receiver, allows movement of the roller to a position different from a position where the roller is normally used in the image forming apparatus.

2. The image forming apparatus according to claim 1, further comprising a cover member that is movable between a first position where the cover member forms at least part of a conveyance path through which the sheet-like medium that is conveyed by the roller passes and a second position where the cover member does not form the conveyance path, wherein
the allower, with the cover member located at the first position, does not allow movement of the roller to a position different from the position where the roller is normally used in the image forming apparatus.

3. The image forming apparatus according to claim 2, wherein
the cover member includes a restriction member that restricts movement of the roller with the cover member located at the first position.

4. The image forming apparatus according to claim 1, further comprising a sheet feed tray that stores a plurality of the sheet-like media in a stack, wherein
the roller is a pickup roller that picks up the sheet-like medium stored in the sheet feed tray,
the image forming apparatus further includes a connection member that pivotally supports a first rotation shaft and is rotatable about a second rotation shaft different from the first rotation shaft, and
the pickup roller is moved between the position where the pickup roller is normally used and a position different from the position where the pickup roller is normally used by rotation of the connection member about the second rotation shaft.

5. The image forming apparatus according to claim 4, further comprising:
a sheet feed roller that conveys the sheet-like medium that has been picked up by the pickup roller; and
a separation roller that is provided opposite to the sheet feed roller and pressed against the sheet feed roller, wherein
the allower, with the separation roller moved to a position where the separation roller does not press the sheet feed roller, allows movement of the pickup roller to a position different from the position where the pickup roller is normally used.

6. A replacement method of replacing a roller that is involved in conveyance of a sheet-like medium in an image forming apparatus, including the steps of:
electrically or mechanically receiving a trigger for replacement of the roller; and
in response to reception of the trigger, allowing movement of the roller to a position different from a position where the roller is normally used in the image forming apparatus.

7. The replacement method according to claim 6, wherein
the image forming apparatus further includes a cover member that is movable between a first position where the cover member forms at least part of a conveyance path through which the sheet-like medium that is conveyed by the roller passes and a second position where the cover member does not form the conveyance path, and
the allowing includes, with the cover member located at the first position, not allowing movement of the roller to a position different from the position where the roller is normally used in the image forming apparatus.

8. The replacement method according to claim 7, wherein
the cover member includes a restriction member that restricts movement of the roller with the cover member located at the first position.

9. The replacement method according to claim 1, wherein
the image forming apparatus further includes a sheet feed tray that stores a plurality of the sheet-like media in a stack,
the roller is a pickup roller that picks up the sheet-like medium stored in the sheet feed tray,
the image forming apparatus further includes a connection member that pivotally supports a first rotation shaft and is rotatable about a second rotation shaft different from the first rotation shaft, and
the pickup roller is moved between the position where the pickup roller is normally used and a position different from the position where the pickup roller is normally used by rotation of the connection member about the second rotation shaft.

10. The replacement method according to claim 9, wherein
the image forming apparatus further includes
a sheet feed roller that conveys the sheet-like medium that has been picked up by the pickup roller, and
a separation roller that is provided opposite to the sheet feed roller and pressed against the sheet feed roller, and
the allowing includes, with the separation roller moved to a position where the separation roller does not press the sheet feed roller, allowing movement of the pickup roller to a position different from the position where the pickup roller is normally used.
